(19) United States
(12) Patent Application Publication
(10) Pub. No.: US 2011/0233039 A1
(43) Pub. Date: Sep. 29, 2011

(54) MOBILE TERMINAL DEVICE AND KEYPAD

(75) Inventors: Hiroyuki TAKITA, Kawasaki (JP); Yoshifumi KAJIWARA, Kawasaki (JP); Haruyoshi YADA, Kawasaki (JP); Kenta SUGIMORI, Kawasaki (JP); Hiroshi KUBO, Kawasaki (JP)

(73) Assignee: FUJITSU LIMITED, Kawasaki-shi (JP)

(21) Appl. No.: 13/047,428

(22) Filed: Mar. 14, 2011

(30) Foreign Application Priority Data
Mar. 26, 2010 (JP) 2010-72090

(51) Int. Cl. H01H 13/76

(52) U.S. Cl. 200/5 A

(57) ABSTRACT

A mobile terminal device includes a keypad including an elastic sheet member, on a first surface of which a plurality of convex pressing portions for pressing switches are formed, and a key top member including first sheet portions disposed in areas overlapping the convex pressing portions, the areas being on a second surface different from the first surface of the elastic sheet member, and second sheet portions disposed in areas other than the areas overlapping the convex pressing portions on the second surface of the elastic sheet member, the second sheet portions having a thickness larger than that of the first sheet portions.

### CROSS-REFERENCE TO RELATED APPLICATIONS

This application is based upon and claims the benefit of priority from the prior Japanese Patent Application No. 2010-72090 filed on Mar. 26, 2010, the entire contents of which are incorporated herein by reference.

### FIELD

The embodiments discussed herein relate to a mobile terminal device and a keypad.

### BACKGROUND

In recent years, mobile terminal devices such as mobile phones are known which have a keypad including a sheet-shaped key top member to be a multifunction key and a numerical keypad as an operation section from the viewpoint of thinning the device and improving the design thereof. As the functions of the device increase these days, on a key top member to be a multifunction key, in addition to operations of cross portions in the up, down, left, and right directions, operations of diagonal portions between the cross portions are performed. For example, when a game function of a mobile terminal device is performed, the diagonal portions of the key top member to be a multifunction key are pressed and operated by a user.

A configuration of the keypad will be described with reference to FIGS. 7 and 8. FIG. 7 is a plan view of the front surface of a keypad 200. FIG. 8 is a plan view of the rear surface of the keypad 200. As illustrated in FIGS. 7 and 8, in the keypad 200, sheet-shaped key top members 220 are attached to the front surface of an elastic sheet member 210, on the rear surface which a plurality of convex pressing portions 211 for pressing switches are formed.

Cross portions 221a to 221d of a key top member 221 to be a multifunction key are disposed on the front surface of the elastic sheet member 210 in positions overlapping the convex pressing portions 211. Diagonal portions 221e to 221h of the key top member 221 are disposed on the front surface of the elastic sheet member 210 in positions other than the positions overlapping the convex pressing portions 211. In other words, the diagonal portions 221e to 221h of the key top member 221 are disposed so that the diagonal portions 221e to 221h are adjacent to two convex pressing portions 211.

When one of the diagonal portions 221e to 221h of the key top member 221 is pressed, two convex pressing portions 211 adjacent to the diagonal portion press two switches at the same time. In this way, pressing operations to the diagonal portions 221e to 221h are detected. The pressing operations to the diagonal portions 221e to 221h of the key top member 221 may be called “diagonal operation”.

As illustrated in Japanese Laid-open Patent Publication No. 2009-224068, a configuration is proposed in which a metal plate to be a reinforcing member is further attached to the rear surface of the keypad and when the diagonal portion of the key top member is pressed, the metal plate presses two switches adjacent to the pressed diagonal portion at the same time, and thereby a diagonal operation is detected.

However, in the keypad in which the key top member is attached to the front surface of the elastic sheet member, there is a problem that is difficult to detect the diagonal operation when the key top member is formed to be relatively thin. This problem will be described with reference to FIGS. 9 and 10. FIG. 9 is an enlarged perspective view of an area around the key top member 221 illustrated in FIG. 7. FIG. 10 is an enlarged cross-sectional view taken along line I-I in FIG. 9. The rigidity of the key top member 221 decreases, when the key top member 221 is formed to be relatively thin. In this case, for example, the key top member 221 bends around the pressed diagonal portion 221g, when the diagonal portion 221g of the key top member 221 is pressed. Therefore, two convex pressing portions 211 adjacent to the diagonal portion 221g may not reliably press two switches, so that the diagonal operation is difficult to be detected.

In a configuration in which a metal plate attached to the rear surface of the keypad presses two switches at the same time, although may prevent the key top member from bending because of the rigidity of the metal plate, the configuration having a problem that the size of the device increases. Specifically, when a metal plated is attached to the rear surface of the key pad, a space for absorbing the thickness of the metal plate is provided in the device housing. Therefore, the size of the device housing increases in the thickness direction of the metal plate.

### SUMMARY

According to an aspect of the embodiment, a mobile terminal device includes a keypad including an elastic sheet member, on a first surface of which a plurality of convex pressing portions for pressing switches are formed, and a key top member including first sheet portions disposed in areas overlapping the convex pressing portions, the areas being on a second surface different from the first surface of the elastic sheet member, and second sheet portions disposed in areas other than the areas overlapping the convex pressing portions on the second surface of the elastic sheet member, the second sheet portions having a thickness larger than that of the first sheet portions.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is an external perspective view illustrating the mobile phone according to this embodiment.

FIG. 2 is an external perspective view illustrating an internal configuration example of the housing from which the exterior cases and the like are removed;

FIG. 3 is a plan view of the front surface of the keypad 100 according to the embodiment;

FIG. 4 is a plan view of the rear surface of the keypad 100 according to the embodiment;

FIG. 5 is an enlarged perspective view of an area around the multifunction key top member illustrated in FIG. 3.

FIG. 6 is an enlarged cross-sectional view taken along line II-II in FIG. 5.

FIG. 7 is a plan view of the front surface of a keypad;

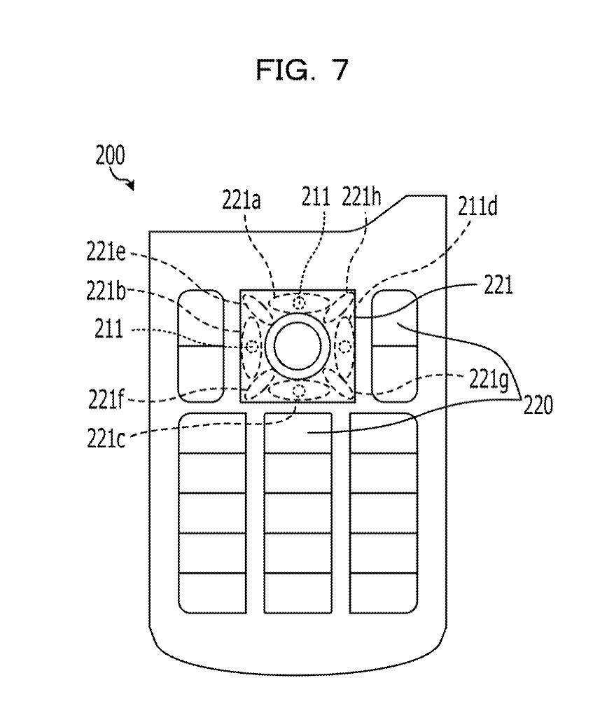

FIG. 8 is a plan view of the rear surface of the keypad;

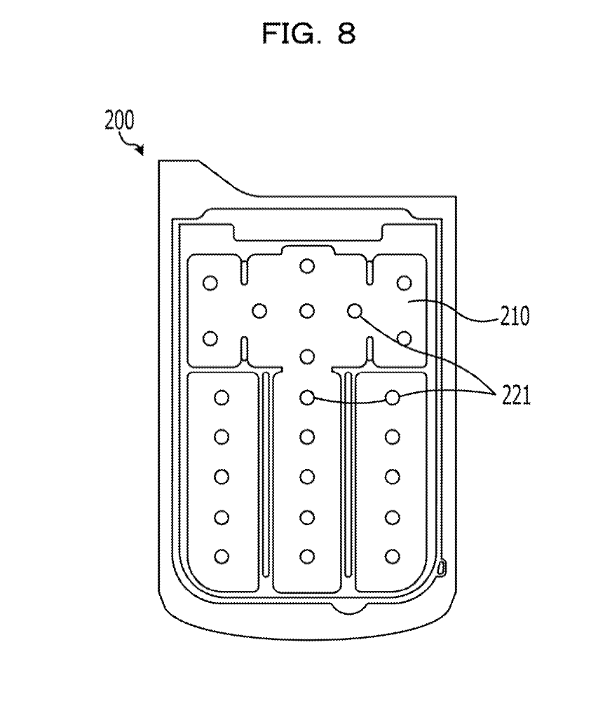

FIG. 9 is an enlarged perspective view of an area around the key top member 221 illustrated in FIG. 7; and

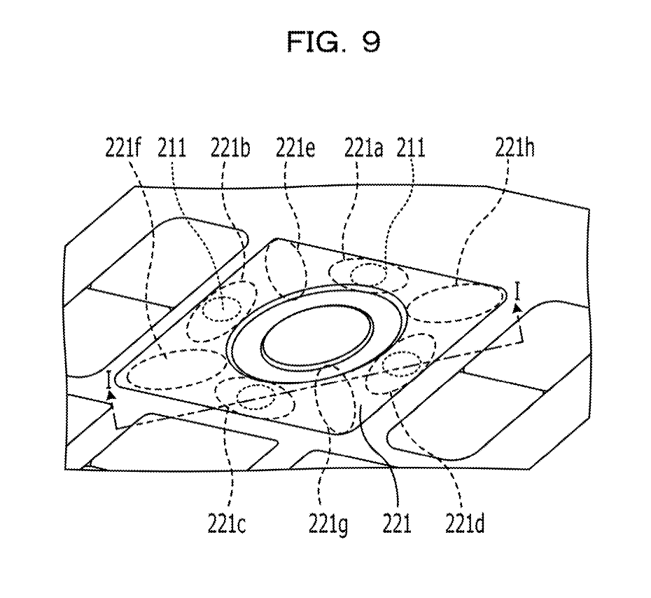

FIG. 10 is an enlarged cross-sectional view taken along line I-I in FIG. 9.

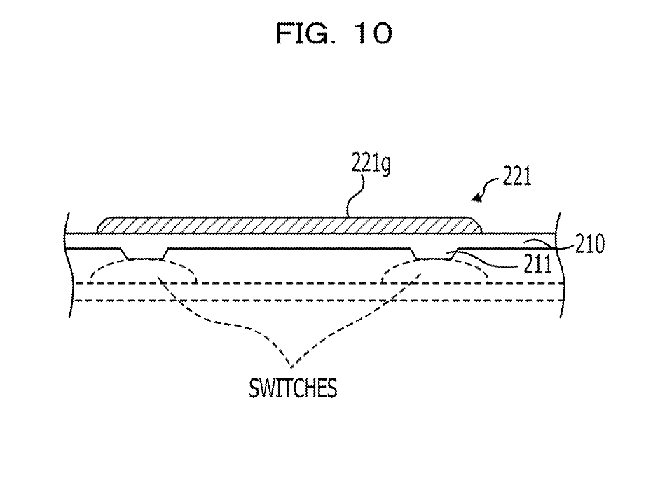

### DESCRIPTION OF EMBODIMENTS

An embodiment of a mobile terminal device and a keypad will be described with reference to the drawings. Although, in this embodiment, an example in which the mobile terminal device is applied to a mobile phone will be described, the mobile terminal device may be applied to other mobile terminal devices such as a PDA (Personal Digital Assistant), for example.

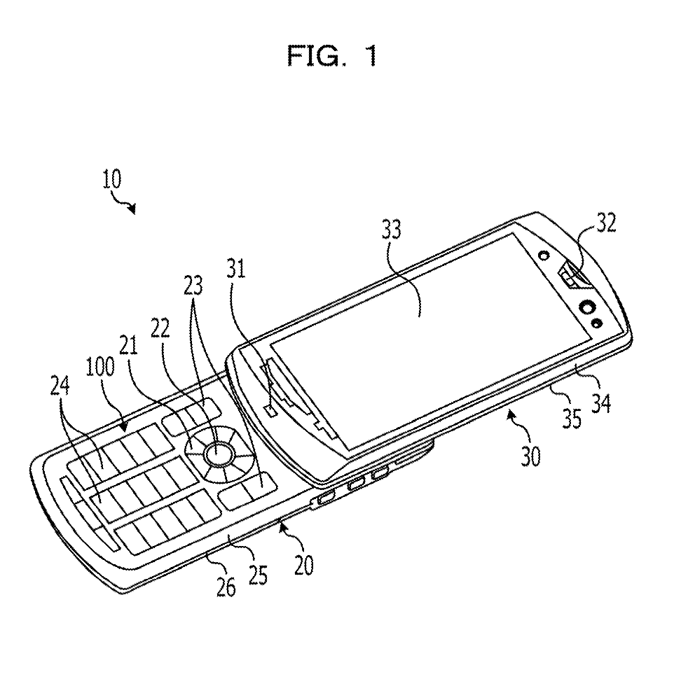

An external configuration of the mobile phone according to this embodiment will be described with reference to FIG. 1. FIG. 1 is an external perspective view illustrating the mobile phone 10 according to the embodiment. The mobile phone 10 according to this embodiment includes two housings 20 and 30 having a palm size. These two housings 20 and 30 are slidably connected to each other via a connection portion such as a slide mechanism.

The housing 20 is a fixed-side housing having a keypad 100 including operation keys such as a multifunction key 21, a decision key 22, mode keys 23, and dial keys 24 functioning as an operation section. The housing 30 is a movable-side housing having a transmitter unit 31, a receiver unit 32, a liquid crystal display unit 33, and the like. FIG. 1 illustrates a state in which the movable-side housing 30 is opened with respect to the fixed-side housing 20 by sliding the movable-side housing 30 with respect to the fixed-side housing 20.

The housing 20 has a structure divided into two parts which are a front exterior case 25 located on the side of the keypad 100 to be an internal surface and a back exterior case 26 located on the back side to be an external surface. The housing 30 has a structure divided into two parts which are a front exterior case 34 located on the side of the liquid crystal display unit 33 to be an external surface and a back exterior case 35 located on the back side to be an internal surface.

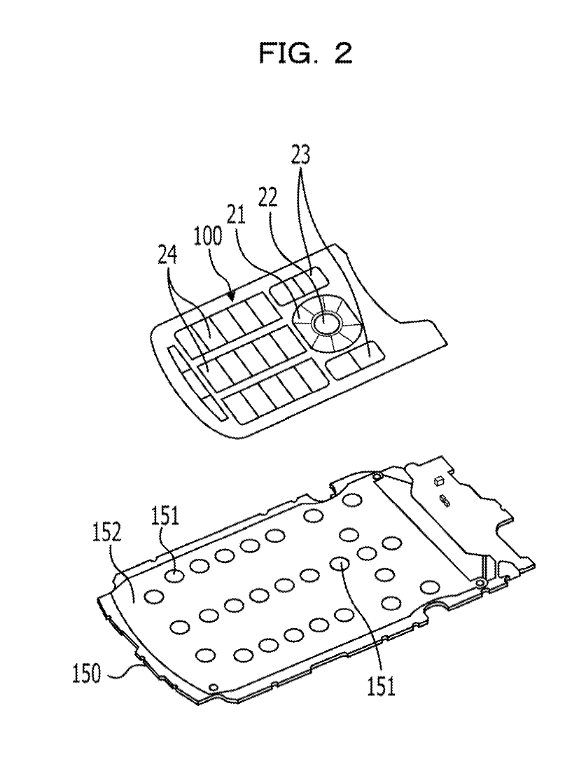

An internal configuration of the housing 20 around the keypad 100 will be described with reference to FIG. 2. FIG. 2 is an external perspective view illustrating an internal configuration example of the housing 20 from which the exterior cases and the like are removed. As illustrated in FIG. 2, the fixed-side housing 20 includes a circuit board 150 supported by an internal frame body or the like. The circuit board 150 is a substrate on which various circuit components are mounted, and a dome sheet 152 on which a plurality of dome switches 151 are arranged is mounted on the front surface of the circuit board 150 which faces the keypad 100. The dome switches 151 are arranged respectively corresponding to the multifunction key 21, the decision key 22, the mode keys 23, and the dial keys 24 included in the keypad 100.

Four dome switches 151 respectively corresponding to four cross portions 21a to 21d described below respectively corresponding to up, down, left, and right directions of the multifunction key 21 are selectively turned on according to a pressing operation to one of the cross portions 21a to 21d of the multifunction key 21. When the diagonal operation is performed, among the four dome switches 151, two dome switches 151 adjacent to one of diagonal portions 21e to 21h of the multifunction key 21 are turned on. A force necessary to press the four dome switches 151 respectively corresponding to the cross portions 21a to 21d of the multifunction key 21 is set to be smaller than a force necessary to press the other dome switches. For example, if the force necessary to press the other dome switches is 1.2 N, the force necessary to press the four dome switches 151 is about 1.0 N, which is set to be smaller than the former force by about 0.2 N. The reason why the pressing force is set to be smaller is, when the diagonal operation is performed, to facilitate pressing the two dome switches 151 adjacent to one of the diagonal portions 21e to 21h of the multifunction key 21 among the four dome switches 151.

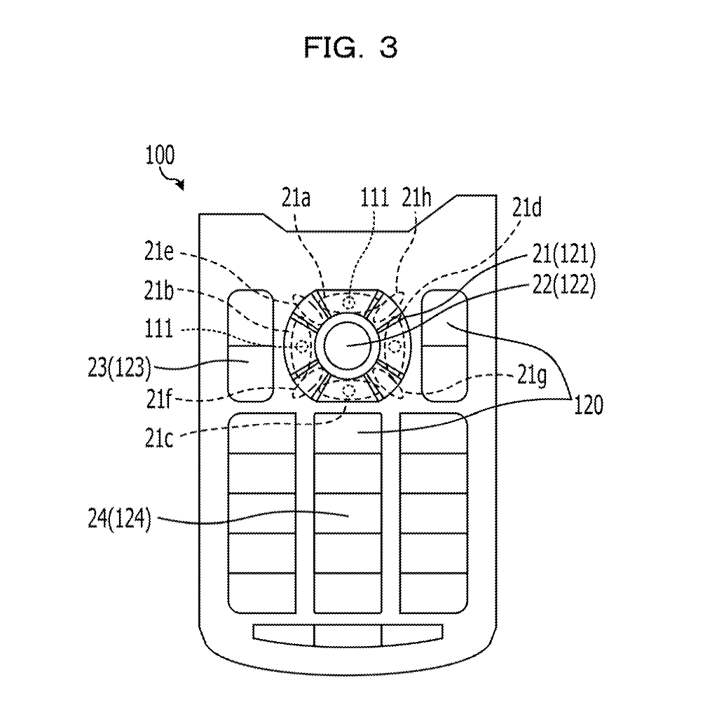

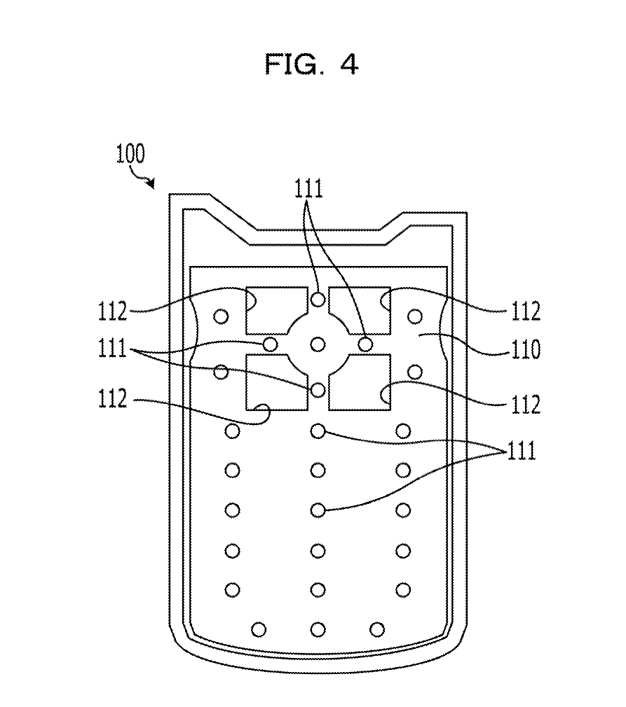

A configuration of the keypad 100 will be specifically described with reference to FIGS. 3 and 4. FIG. 3 is a plan view of the front surface of the keypad 100 according to the embodiment. FIG. 4 is a plan view of the rear surface of the keypad 100 according to the embodiment. As illustrated in FIGS. 3 and 4, the keypad 100 includes an elastic sheet member 110 and a key top members 120 attached to the front surface of the elastic sheet member 110.

The elastic sheet member 110 is a sheet-shaped member formed of an elastic material such as silicon, and a plurality of convex pressing portions 111 are formed on the rear surface of the elastic sheet member 110. The rear surface may be called the first surface. The convex pressing portions 111 are respectively disposed corresponding to the dome switches 151 on the dome sheet 152 and function as pressing portions for pressing the dome switches 151. Among the convex pressing portions 111, four convex pressing portions 111 respectively corresponding to the four cross portions 21a to 21d in the up, down, left, and right directions of the multifunction key 21 selectively press four dome switches 151 according to a pressing operation to one of the cross portions 21a to 21d of the multifunction key 21.

The key top member 120 is a sheet-shaped member formed of a rigid material such as polycarbonate, and attached to the front surface of the elastic sheet member 110 with an adhesive or the like. The front surface may be called the second surface. The key top members 120 include a multifunction key top member 121 to be the multifunction key 21, a decision key top member 122 to be the decision key 22, mode key top members 123 to be the mode keys 23, dial key top members 124 to be the dial keys 24, and the like. Among the key top members 120, the multifunction key top member 121 detects pressing operations of the diagonal portions 21e to 21h located between the cross portions 21a to 21d in addition to pressing operations of the cross portions 21a to 21d in the up, down, left, and right directions. The pressing operations to the diagonal portions 21e to 21h of the multifunction key top member 121 may be called “diagonal operation.”

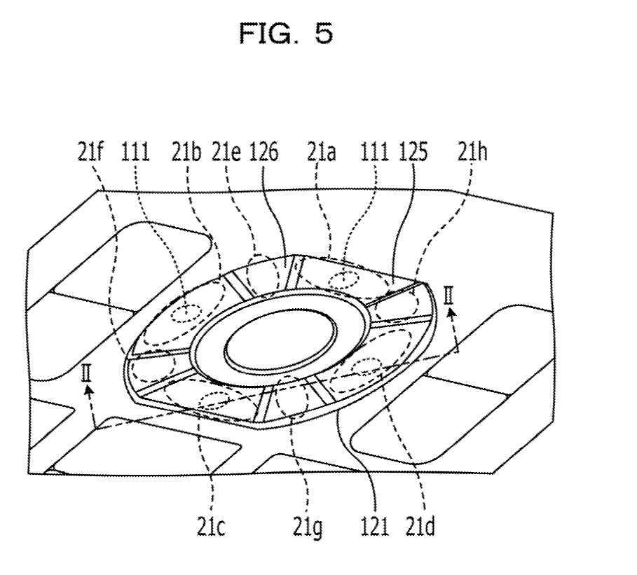

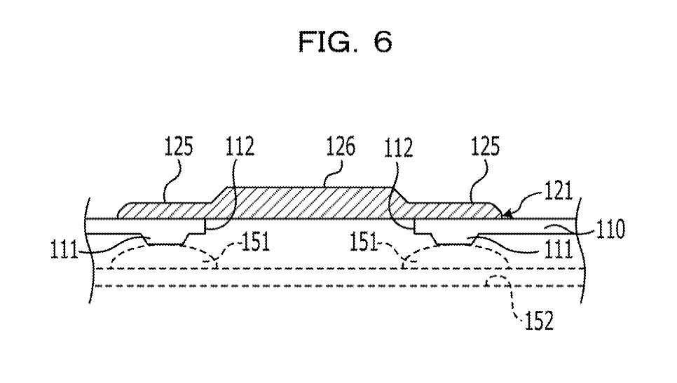

A configuration around the multifunction key top member 121 for detecting the diagonal operation will be described with reference to FIGS. 5 and 6. FIG. 5 is an enlarged perspective view of an area around the multifunction key top member 121 illustrated in FIG. 3. FIG. 6 is an enlarged cross-sectional view taken along line II-II in FIG. 5. As illustrated in FIGS. 5 and 6, the multifunction key top member 121 includes first sheet portions 125 and second sheet portions 126 as one body.

The first sheet portions 125 respectively correspond to the cross portions 21a to 21d of the multifunction key top member 121 to be a multifunction key 21, and are disposed on the front surface of the elastic sheet member 110 in positions overlapping the convex pressing portions 111.

The second sheet portions 126 respectively correspond to the diagonal portions 21e to 21h located between the cross portions 21a to 21d of the multifunction key top member 121, and are disposed on the front surface of the elastic sheet member 110 in positions other than the positions overlapping the convex pressing portions 111. The second sheet portions 126 are formed to have a thickness larger than that of the first sheet portions 125 disposed in the positions overlapping the convex pressing portions 111. For example, the second sheet portions 126 are formed to have a thickness larger than that of the first sheet portions 125 by about 0.1 to 2.0 mm. The second sheet portions 126 are formed to have a thickness larger than that of the first sheet portions 125 in a state in which the second sheet portions 126 protrude in the direction opposite to the direction in which the convex pressing portions 111 of the elastic sheet member 110 protrude.

Cutout portions 112 that penetrate the elastic sheet member 110 in the thickness direction are provided in locations corresponding to the second sheet portions 126 of the elastic sheet member 110, in other words, in locations corresponding to the diagonal portions 21e to 21h of the multifunction key top member 121 of the elastic sheet member 110.

An action of the keypad 100 when detecting the diagonal operation will be described. In this embodiment, one of the second sheet portions 126 corresponding to one of the diagonal portions 21e to 21h of the multifunction key top member 121 is pressed by a user.

In the key pad 100 according to the embodiment, the second sheet portions 126 of the multifunction key top member 121 are formed to have a thickness larger than that of the first sheet portions 125 disposed in the positions overlapping the convex pressing portions 111. In other words, the rigidity of the second sheet portions 126 is larger than that of the first sheet portions 125. Based on this, in the key pad 100, even when a second sheet portion 126 of the multifunction key top member 121 is pressed, the second sheet portion 126, which has a large rigidity, is difficult to be bent. Therefore, the pressing force to the second sheet 126 is reliably transmitted to two convex pressing portions 111 adjacent to the second sheet 126 via the first sheet portions 125, and the two adjacent convex pressing portions 111 press two dome switches 151 at the same time. As a result, the keypad 100 may easily detect the diagonal operation. Since the first sheet portions 125 and the second sheet portions 126 formed to have a thickness larger than that of the first sheet portions 125 in the multifunction key top member 121 are formed into one sheet-shaped body, other rigidity-reinforcing components such as metal plates need not be added, so that the size of the device may be prevented from increasing.

In the key pad 100 according to the embodiment, the second sheet portions 126 of the multifunction key top member 121 are formed to have a thickness larger than that of the first sheet portions 125 in a state in which the second sheet portions 126 protrude in the direction opposite to the direction in which the convex pressing portions 111 of the elastic sheet member 110 protrude. Therefore, the keypad 100 may secure a gap between a second sheet portion 126 of the multifunction key top member 121 and the dome sheet 152, and may easily secure a stroke length to fully press the second sheet portion 126 when the diagonal operation is performed. As a result, the keypad 100 may easily detect the diagonal operation.

In the key pad 100 according to the embodiment, the cutout portions 112 are provided in the elastic sheet member 110 in locations corresponding to the second sheet portions 126. Therefore, a second sheet portion 126 pressed by a user travels in a straight line in the cutout portion 112, so that it may be possible to prevent the second sheet portion 126 from pulling the inner circumferential portion of the elastic sheet member 110 corresponding to the second sheet portion 126. As a result, the keypad 100 may improve the click feeling when pressing the second sheet portion 126, so that the keypad 100 may more easily detect the diagonal operation.

According to the embodiment, the second sheet portions 126 corresponding to the diagonal portions between the cross portions are formed to have a thickness larger than that of the first sheet portions 125 corresponding to the cross portions in the multifunction key. Therefore, the rigidity of the diagonal portions in the multifunction key increase to be greater than the rigidity of the cross portions, and two convex pressing portions 111 adjacent to a diagonal portion reliably press two dome switches 151. As a result, the diagonal operation may be easily detected. Further, reinforcing members such as metal plates need not be added, so that the size of the device may be prevented from increasing.

Although, in the embodiment, a slide-type mobile phone using a slide mechanism that slidably connects the housings 20 and 30 is described as an example, the mobile terminal device may be applied to mobile terminal devices other than slide-type mobile terminal devices. For example, the mobile terminal device may also be applied to mobile terminal devices in which one housing is movable with respect to the other housing by a folding-type connection or a plane-rotation-type connection.

Although, in the embodiment, an application example applied to a mobile phone, which is an example of a mobile terminal apparatus, is described, the mobile terminal device is not limited to this. For example, the mobile terminal device may be applied to other various mobile terminal devices such as a small-sized information processing terminal like a PDA, a small music player, a mobile TV, and a portable game machine.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that the various changes, substitutions, and alterations could be made hereto without departing from the spirit and scope of the invention.

What is claimed is:

1. A mobile terminal device comprising:
a keypad including,
an elastic sheet member, on a first surface of which a plurality of convex pressing portions for pressing switches are formed, and
a key top member including first sheet portions disposed in areas overlapping the convex pressing portions, the areas being on a second surface different from the first surface of the elastic sheet member, and second sheet portions disposed in areas other than the areas overlapping the convex pressing portions on the second surface of the elastic sheet member, the second sheet portions having a thickness larger than that of the first sheet portions.

2. The mobile terminal device according to claim 1, wherein the first sheet portions and the second sheet portions are integrated into one body.

3. The mobile terminal device according to claim 1, wherein the second sheet portions are formed to have a thickness larger than that of the first sheet portions when the second sheet portions protrude in a direction opposite to a direction in which the convex pressing portions protrude.

4. The mobile terminal device according to claim 1, wherein the elastic sheet member includes cutout portions penetrating the elastic sheet member in a thickness direction in areas corresponding to the second sheet portions.

5. A keypad comprising:
an elastic sheet member, on a first surface of which a plurality of convex pressing portions for pressing switches are formed, and
a key top member including first sheet portions attached to a second surface different from the first surface of the elastic sheet member and disposed on the second surface of the elastic sheet member in positions overlapping the convex pressing portions, and second sheet portions disposed on the second surface of the elastic sheet member in positions other than the positions overlapping the convex pressing portions, the second sheet portions having a thickness larger than that of the first sheet portions.
